(19) United States
(12) Patent Application Publication
(10) Pub. No.: US 2016/0108999 A1
(43) Pub. Date: Apr. 21, 2016

(54) SPINDLE NUT AND ASSOCIATED BALL SCREW DRIVE

(71) Applicant: SCHAEFFLER TECHNOLOGIES AG & CO. KG, Herzogenaurach (DE)

(72) Inventor: Mario Kreutzer, Sonneberg (DE)

(73) Assignee: Schaeffler Technologies AG & Co. KG, Herzogenaurach (DE)

(21) Appl. No.: 14/787,150

(22) PCT Filed: Feb. 27, 2014
(86) PCT No.: PCT/DE2014/200097

§ 371 Date: Oct. 26, 2015

(30) Foreign Application Priority Data
Apr. 26, 2013 (DE) 10 2013 207 618.5

(51) Int. Cl. F16H 25/22

(52) U.S. Cl. CPC F16H 25/2204; F16H 2025/2242

(57) ABSTRACT

Spindle nut (1) for a ball screw drive, having a fixed external diameter (AD), a helical ball groove which is formed on the inner side (2) thereof, an inner ring (5) which is formed on the outer side thereof, has an annular ball groove (4) and forms a supporting bearing (6) together with an outer ring (8) and balls (7) which are arranged in between. The inner ring (5) has a first stepped section (10) which extends as far as the ball groove (4), has a fixed outer diameter (Si1) and is adjoined on the other side of the ball groove (4) by a second stepped section (11) having a reduced outer diameter (Si2).

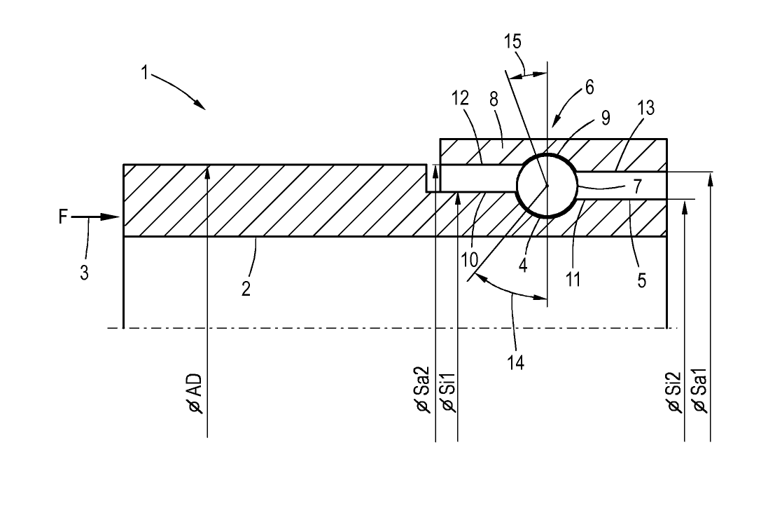

### FIELD OF THE INVENTION

The invention relates to a spindle nut for a ball screw drive with a fixed outer diameter, a helical ball groove formed on its inner side, and an inner ring that is formed on its outer side and has a ring-shaped ball groove and forms, together with an outer ring and balls arranged in-between, a support bearing.

### BACKGROUND

A spindle nut is part of a ball screw drive that converts a rotational motion between a threaded spindle and the spindle nut into a displacement between the threaded spindle and the spindle nut.

For certain applications of a ball screw drive, primarily an axial main load exists. In addition, applications are possible in which the support bearing provided on the spindle nut should replace a separate radial bearing, e.g., for a coupling with an electric motor or a belt drive.

It is already known to combine a ball screw drive or its spindle nut with a separate axial bearing and/or a separate radial bearing or a four-point bearing in order to provide a ball screw drive with a bearing function. Here it is disadvantageous, however, that the necessary installation space is large due to the multiple individual bearings that are required, plus, if necessary, additional components, such as spring elements or the like, are required. Conventional four-point bearings are rejected for certain applications for reasons of costs, plus they require axial securing of the inner rings. A conventional four-point bearing with one-part rings and symmetrical tracks that would normally be considered for such applications requires a relatively large installation space.

In DE 10 2007 026 605 A1, a ball screw drive was proposed in which the spindle nut has, on one end, a section with enlarged diameter that has, on its outer side, a ball groove for forming a bearing.

From DE 10 2004 040 360 A1, a ball screw drive is known whose spindle nut has, on one end, a molded ball groove, so that a ring can be supported by means of rolling bodies so that it can rotate relative to the spindle nut.

From DE 10 2009 031 711 A1, a spindle nut for a ball screw drive is known that has, on one end, a step with an increased diameter on the outside, wherein, in the region of the step, a separate inner ring is fastened, whereby a ball groove for balls is formed through which an outer ring is supported so that it can rotate relative to the spindle nut.

### SUMMARY

The invention is based on the objective of providing a spindle nut for a ball screw drive that has minimal installation space requirements and can be produced easily and cost-effectively.

To achieve this objective, for a spindle nut of the type mentioned above, it is provided according to the invention that the inner ring has a first stepped section with fixed outer diameter, wherein this first section extends up to the ball groove and is adjacent to a second stepped section with a reduced outer diameter on the other side of the ball groove.

According to the invention it is thus provided that the spindle nut has multiple steps on its outer side. Over the greatest part of its length, the spindle nut has a constant, defined outer diameter. In the region of one end, the spindle nut has, on its outer side, a circumferential, ring-shaped ball groove that is suitable for forming a support bearing. A first section with fixed diameter extends from the section with the defined outer diameter up to the ball groove. This first section has a reduced or enlarged outer diameter relative to the defined outer diameter of the spindle nut. A second stepped section with a reduced outer diameter extends to the other, opposing side of the ball groove. This reduced outer diameter is smaller than the outer diameter of the first stepped section.

According to the invention it is preferred that the outer ring has a first shoulder (Sa2) with a fixed inner diameter, wherein this first shoulder extends up to the ball groove of the outer ring and is adjacent to a second stepped shoulder with an enlarged inner diameter (Sa1) on the other side of the ball groove. Accordingly, the outer ring has, on two sides of the ball groove, similar stepped sections as the spindle nut. By defining the steps or their outer diameters, the pressure angle on the spindle nut can be increased and fixed until a maximum load bearing capacity is produced in the main loading direction, that is, in the axial direction. On the other hand, the pressure angle set on the outer ring can be reduced as much as possible for a certain radial load. The same applies to the second stepped section with the reduced outer diameter (Si2) and the second shoulder of the outer ring with the fixed inner diameter (Sa1). These diameters are reduced as much as possible for the given radial load.

It is also within the scope of the invention that the difference of the inner diameter (Sa1) of the second shoulder of the outer ring and the section of the first inner ring with fixed outer diameter (Si1) is greater than the diameter of a ball. This arrangement guarantees trouble-free assembling of the bearing. Similarly, for the spindle nut according to the invention it is preferred that the difference of the inner diameter (Sa2) of the first shoulder of the outer ring and the second stepped section of the inner ring with reduced outer diameter (Si2) is greater than the diameter of a ball. For guaranteeing problem-free assembly, both conditions must be adhered to.

One refinement of the invention provides that the ring-shaped ball groove of the inner ring has an asymmetrical Gothic-style profile. Accordingly, a ball contacts the ball groove at two points spaced apart from each other.

Advantageously, the ring-shaped ball groove of the outer ring also has an asymmetrical Gothic-style profile.

One variant of the spindle nut according to the invention can provide that the inner ring is produced as a separate part and connected to the spindle nut, in particular, pressed onto the spindle nut.

The invention also relates to a ball screw drive with a spindle with a helical ball groove, a spindle nut, and balls arranged between the spindle and spindle nut. The ball screw drive according to the invention distinguishes itself in that it has a spindle nut of the described type.

### BRIEF DESCRIPTION OF THE DRAWINGS

One embodiment of the invention is shown in the drawing and is described in more detail below.

The drawing shows a sectioned side view of a spindle nut according to the invention.

### DETAILED DESCRIPTION OF THE PREFERRED EMBODIMENTS

The FIGURE shows a spindle nut 1 for a ball screw drive in a sectioned side view. With respect to the radial symmetry, only one half of the spindle nut 1 is shown. The spindle nut 1 has a tubular shape; on its inner side 2 it has a (not shown) helical ball screw. The ball screw is used as a track for rolling bodies that are formed as balls and by which the spindle nut 1 can be moved relative to a spindle. The spindle also has on its outer side a corresponding helical ball groove. By a rotational movement of the spindle or the spindle nut that is realized by an electrical drive, the non-driven component is displaced in the axial direction.

An arrow 3 shows that the spindle nut 1 is loaded primarily in the axial direction. So that the spindle nut 1 can simultaneously take over the function of a radial bearing, the spindle nut 1 has, on its outer side, a ring-shaped ball groove 4 that is part of an inner ring 5 of a support bearing 6. In addition to the inner ring 5 and balls 7, the support bearing 6 also comprises an outer ring 8 that has a ball groove 9.

The inner ring 5 has a first stepped section 10 with a fixed outer diameter (Si1), wherein this first section extends up to the ball groove 4 and is adjacent to a second stepped section 11 with a reduced outer diameter (Si2) on the opposing side of the ball groove 4. The outer diameter (Si1) of the first stepped section 10 is smaller in this embodiment than the outer diameter (AD) of the spindle nut 1; the outer diameter (Si2) of the second stepped section 11 is smaller than the outer diameter (Si1) of the first stepped section 10. The outer diameter AD is defined within the scope of the design of the ball screw drive. This outer diameter could be either greater than or smaller than the fixed outer diameter (Si1).

The outer ring 8 that is part of the support bearing 6 has a first shoulder 13 with a defined inner diameter (Sa2), wherein this first shoulder extends up to the ball groove 9 and is adjacent to a second stepped shoulder 12 with an enlarged inner diameter (Sa1) on the opposing side of the ball groove 9. To guarantee the ability to assemble the support bearing 6, the difference of the inner diameter (Sa1) of the second shoulder 12 of the outer ring and the first stepped section 10 of the inner ring 5 with defined outer diameter (Si1) is greater than the diameter of a ball 7. The additional condition is also fulfilled that the difference of the inner diameter (Sa2) of the first shoulder 13 of the outer ring 8 and the second stepped section 11 of the inner ring 5 with reduced outer diameter (Si2) is greater than the diameter of a ball 7.

In the shown embodiment, both the ring-shaped ball groove 4 of the inner ring 5 and also the ring-shaped ball groove 9 of the outer ring 8 have an asymmetrical Gothic-style profile.

For the spindle nut 1, the pressure angle 14 produced on the inner ring 5 and also the diameter of the first stepped section 10 with fixed outer diameter (Si1) extending up to the ball groove have been increased in the main loading direction specified by the arrow 3 such that the load bearing capacity of the support bearing 6 is at a maximum for a defined load. In contrast, the pressure angle 15 set on the outer ring 8 and the reduced outer diameter (Si2) of the second stepped section 11 and the inner diameter (Sa1) of the second shoulder 12 of the outer ring 8 are reduced as much as required for a specified radial load.

One variant of the embodiment shown in the drawing provides that the inner ring is produced as a separate part and is connected to the spindle nut, in particular, the inner ring can be pressed onto the spindle nut.

### LIST OF REFERENCE NUMBERS

1 Spindle nut
2 Inner side
3 Arrow
4 Ball groove
5 Inner ring
6 Support bearing
7 Ball
8 Outer ring
9 Ball groove
10 Section
11 Section
12 Shoulder
13 Shoulder
14 Pressure angle
15 Pressure angle

1. A spindle nut for a ball screw drive, comprising a fixed outer diameter (AD), a helical ball groove formed on an inner side thereof, an inner ring formed on an outer side thereof with a ring-shaped ball groove that forms, together with an outer ring and balls arranged in-between, a support bearing, the inner ring has a first stepped section that extends up to the ball groove with a fixed outer diameter (Si1) and contacts, on an other side of the ball groove, a second stepped section with a reduced outer diameter (Si2), the outer ring has a first shoulder that extends up to the ball groove of the outer ring with a fixed inner diameter (Sa2) and contacts, on the other side of the ball groove, a second stepped shoulder with an increased inner diameter (Sa1), a difference of the inner diameter (Sa1) of the second shoulder of the outer ring and the first stepped section of the inner ring with the fixed outer diameter (Si1) is greater than a diameter of one of the balls, and a difference of the inner diameter (Sa2) of the first shoulder of the outer ring and the second stepped section of the inner ring with reduced outer diameter (Si2) is greater than the diameter of one of the balls.

2.-4. (canceled)

5. A spindle nut according to claim 1, wherein the ring-shaped ball groove of the inner ring has an asymmetrical Gothic-style profile.

6. The spindle nut according to claim 1, wherein the ring-shaped ball groove of the outer ring has an asymmetrical Gothic-style profile.

7. The spindle nut according to claim 1, wherein the inner ring is produced as a separate component and is connected to the spindle nut.

8. A ball screw drive with a spindle with a helical ball groove, a spindle nut, and balls arranged between the spindle and spindle nut, wherein the spindle nut is formed according to claim 1.
